(19) United States
(12) Patent Application Publication
(10) Pub. No.: US 2024/0163847 A1
(43) Pub. Date: May 16, 2024

(54) COMMUNICATION DEVICE, COMMUNICATION METHOD, COMMUNICATION SYSTEM, AND PROGRAM

(71) Applicant: SONY GROUP CORPORATION, TOKYO (JP)

(72) Inventors: HIROKI MATSUDA, TOKYO (JP); MITSUKI TAKAHASHI, TOKYO (JP); RYOTA KIMURA, TOKYO (JP); YUKITOSHI SANADA, KANAGAWA (JP)

(21) Appl. No.: 18/550,539

(22) PCT Filed: Feb. 24, 2022
(86) PCT No.: PCT/JP2022/007453

§ 371 Date: Sep. 14, 2023

(30) Foreign Application Priority Data
Mar. 26, 2021 (JP) 2021-054084

(51) Int. Cl. H04W 72/02; H04L 5/00; H04W 72/0453

(52) U.S. Cl. CPC H04W 72/02; H04L 5/0051; H04W 72/0453

(57) ABSTRACT

To provide a communication device and the like that suppress deterioration in accuracy of wireless communication while partially omitting initial processing of wireless communication connection between a wireless communication terminal and a base station. A communication device according to one aspect of the present disclosure includes a determination unit and a wireless communication unit. The determination unit determines, upon receiving wireless communication from a communication counterpart with which wireless communication connection is not established, to perform wireless communication on a first channel for transmitting data with the communication counterpart. The wireless communication unit transmits wireless communication on the first channel to the communication counterpart when it is determined to perform wireless communication on the first channel.

### TECHNICAL FIELD

The present disclosure relates to communication devices, communication methods, communication systems, and programs.

### BACKGROUND ART

In the 3rd Generation Partnership Project (3GPP), wireless access methods and wireless networks for cellular mobile communication are being studied, but there is a need for a mechanism for realizing even lower latency communication.

For example, with the spread of IoT (Internet of Things) technology, it is believed that wireless communication will be performed in various places. For example, a wireless communication terminal such as a sensing device is placed near a device installed in a location that is difficult for surveillance personnel to access in order to monitor the device, and the collected data is wirelessly transmitted to a datacenter or the like. However, it is believed that fixed base stations for communication connection between networks such as the Internet and wireless communication terminals are not maintained to cover all wireless communication terminals due to enormous installation costs.

For this reason, it is being considered to recover data collected by wireless communication terminals located in areas where there are no fixed base stations, using mobile base stations. For example, the collected data can be recovered by transmitting the sensing data stored in the wireless communication terminals to mobile base stations when communication with the mobile base stations becomes possible using low earth orbit satellites, cars, or the like as mobile base stations.

Such mobile base stations may be constantly moving. In that case, the time during which the wireless communication terminal can transmit data to the mobile base station is limited. For example, if the mobile base station is a low earth orbit satellite, the communication available time may be on the order of several seconds.

If most of the wireless communication terminals attempt to transmit data to the mobile base station at approximately the same time, connection failures and long delays may occur. As a result, it is conceivable that data transmission will not be completed within the time.

### CITATION LIST

### Non Patent Literature

[NPL 1] 3GPP, “R1-1911405, Channel Structure for Two-Step RACH”, https://portal.3gpp.org/ngppapp/TdocList.aspx?meetingId=32826

### SUMMARY

### Technical Problem

In order to secure the time for data transmission and to reduce the delay, it is being considered to partially omit the initial processing of wireless communication connection between a wireless communication terminal and a base station. However, this omission poses a problem that the accuracy of wireless communication deteriorates.

Accordingly, the present disclosure presents a communication device and the like that suppress deterioration in the accuracy of wireless communication while partially omitting initial processing of wireless communication connection between a wireless communication terminal and a base station.

### Solution to Problem

A communication device according to one aspect of the present disclosure includes a determination unit and a wireless communication unit. The determination unit determines, upon receiving wireless communication from a communication counterpart with which wireless communication connection is not established, to perform wireless communication on a first channel for transmitting data with the communication counterpart. The wireless communication unit transmits wireless communication on the first channel to the communication counterpart when it is determined to perform wireless communication on the first channel.

When it is determined to perform wireless communication on the first channel, the determination unit may determine to extend a frequency range in the first channel, the frequency range determined in advance to be allocatable for transmission of a first signal included in the wireless communication transmitted to the communication counterpart, the determination unit may determine a frequency to be allocated for transmission of the first signal in the extended frequency range, and the wireless communication unit may transmit the first signal on a frequency determined to be allocated for transmission of the first signal in the wireless communication with the communication counterpart on the first channel.

A plurality of frequencies may be selected for allocation for transmission of the first signal, the plurality of selected frequencies may include at least one frequency in an extended portion of the extended frequency range, and the first signal may be transmitted on each of the plurality of selected frequencies at a same timing.

The plurality of selected frequencies may not match a frequency on which another communication device that performs wireless communication with the communication counterpart transmits the first signal.

When it is determined not to extend the frequency range, the determination unit may determine a frequency to be allocated for transmission of the first signal in the frequency range that is not extended, and the number of frequencies allocated for transmission of the first signal when the frequency range is extended may be greater than the number of frequencies allocated for transmission of the first signal when the frequency range is not extended.

When it is determined not to extend the frequency range, the determination unit may determine a frequency to be allocated for transmission of the first signal in the frequency range that is not extended, and an interval of frequencies allocated for transmission of the first signal when the frequency range is extended may be longer than an interval of frequencies allocated for transmission of the first signal when the frequency range is not extended.

When it is determined not to extend the frequency range, the determination unit may determine a frequency to be allocated for transmission of the first signal in the frequency range that is not extended, and all frequencies allocated for transmission of the first signal when the frequency range is not extended may be selected as frequencies allocated for transmission of the first signal when the frequency range is extended.

The determination unit may determine to extend the frequency range based on a notification from the communication counterpart.

The determination unit may determine to restore the extended frequency range based on a notification from the communication counterpart, and all frequencies of the first signal transmitted after it is determined to restore the extended frequency range may be within the frequency range that is not extended.

The wireless communication on the first channel may be performed by non-orthogonal multiplex communication.

The first signal may be a reference signal or a cyclic prefix.

When it is determined not to perform wireless communication on the first channel, the wireless communication unit may transmit wireless communication on a second channel for the wireless communication connection to the communication counterpart.

Another aspect of the present disclosure provides a communication method including: receiving wireless communication from a communication counterpart with which wireless communication connection is not established; determining to perform wireless communication with the communication counterpart on a first channel for transmitting data; and transmitting wireless communication on the first channel to the communication counterpart when it is determined to perform wireless communication on the first channel.

The communication method may further include when it is determined to perform wireless communication on the first channel, determining to extend a frequency range in the first channel, the frequency range determined in advance to be allocatable for transmission of a first signal included in the wireless communication transmitted to the communication counterpart; and determining a frequency to be allocated for transmission of the first signal in the extended frequency range, wherein the first signal may be transmitted on a frequency determined to be allocated for transmission of the first signal in the wireless communication with the communication counterpart on the first channel.

Another aspect of the present disclosure provides a communication system including: one or more first communication devices; and a second communication device that performs wireless communication with the first communication device, wherein the first communication device includes: a determination unit that determines, upon receiving wireless communication from the first communication device which has not established wireless communication connection with the first communication device, to perform wireless communication on a first channel for transmitting data with the first communication device; and a wireless communication unit that transmits wireless communication on the first channel to the first communication device when it is determined to perform wireless communication on the first channel.

In the communication system, when it is determined to perform wireless communication on the first channel, the determination unit determines to extend a frequency range in the first channel, the frequency range determined in advance to be allocatable for transmission of a first signal included in the wireless communication transmitted to the second communication device, the determination unit determines a frequency to be allocated for transmission of the first signal in the extended frequency range, and the wireless communication unit transmits the first signal on a frequency determined to be allocated for transmission of the first signal in the wireless communication with the second communication device on the first channel.

Another aspect of the present disclosure provides a program executed by a computer, including: receiving wireless communication from a communication counterpart with which wireless communication connection is not established; determining to perform wireless communication with the communication counterpart on a first channel for transmitting data; and transmitting wireless communication on the first channel to the communication counterpart when it is determined to perform wireless communication on the first channel.

The program may further include when it is determined to perform wireless communication on the first channel, determining to extend a frequency range in the first channel, the frequency range determined in advance to be allocatable for transmission of a first signal included in the wireless communication transmitted to the communication counterpart; and determining a frequency to be allocated for transmission of the first signal in the extended frequency range, wherein the first signal is transmitted on a frequency determined to be allocated for transmission of the first signal in the wireless communication with the communication counterpart on the first channel.

### BRIEF DESCRIPTION OF DRAWINGS

FIG. 1 is a diagram showing a configuration example of a communication system according to an embodiment of the present disclosure.

FIG. 2 is a diagram showing an arrangement example of a base station device.

FIG. 3 is a diagram showing a first example of a conventional resource grid.

FIG. 4 is a diagram showing a first example of a resource grid according to the present embodiment.

FIG. 5 is a diagram showing a second example of the resource grid according to the present embodiment.

FIG. 6 is a diagram showing a third example of the resource grid according to the present embodiment.

FIG. 7 is a diagram showing a second example of the conventional resource grid.

FIG. 8 is a diagram showing a fourth example of the resource grid according to the present embodiment.

FIG. 9 is a diagram showing parameter values for Configuration type 1.

FIG. 10 is a diagram showing parameter values for Configuration type 2.

FIG. 11 is a diagram showing parameter values for Configuration type 3.

FIG. 12 is a diagram showing a first example of NOMA transmission.

FIG. 13 is a diagram showing a second example of NOMA transmission.

FIG. 14 is a diagram showing a third example of NOMA transmission.

FIG. 15 is a diagram showing a fourth example of NOMA transmission.

FIG. 16 is a diagram showing a fifth example of NOMA transmission.

FIG. 17 is a diagram showing an example of a wireless communication sequence between a communication terminal and a base station device.

FIG. 18 is a diagram showing simulation conditions.

FIG. 19 is a first diagram for explaining simulation results.

FIG. 20 is a second diagram for explaining simulation results.

FIG. 21 is a third diagram for explaining simulation results.

FIG. 22 is a fourth diagram for explaining simulation results.

### DESCRIPTION OF EMBODIMENTS

### One Embodiment of Present Invention

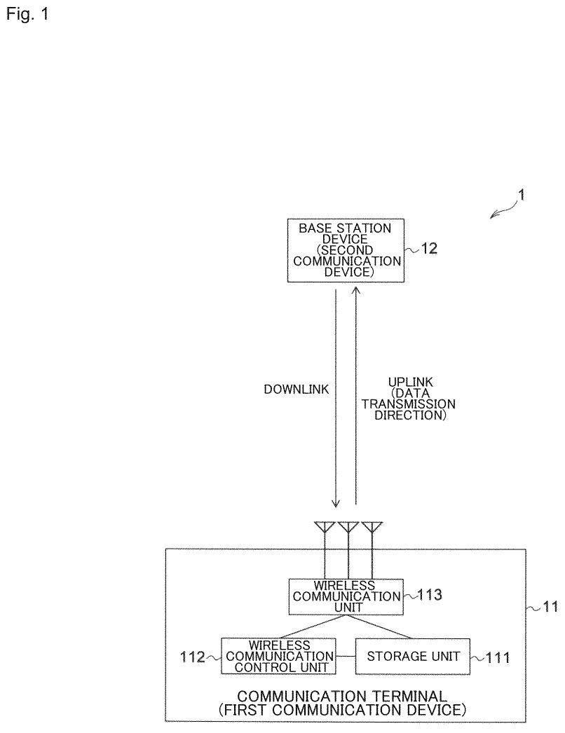

FIG. 1 is a diagram showing a configuration example of a communication system according to an embodiment of the present disclosure. A communication system 1 in FIG. 1 includes a communication terminal (first communication device) 11 and a base station device (second communication device) 12. The communication terminal 11 also includes a storage unit 111, a wireless communication control unit (determination unit) 112, and a wireless communication unit 113. In the present disclosure, the other components of the communication terminal 11 may be the same as those of the existing communication terminal, and therefore, the description thereof will be omitted. A plurality of communication terminals 11 may belong to the communication system 1.

In the example of FIG. 1, it is assumed that the communication system 1 is a cellular communication system using radio access technologies such as LTE (Long Term Evolution) and NR (New Radio). The terms used in the present disclosure are used to deepen the understanding of the present embodiment, and are not intended to impose unreasonable limitations. For example, LTE has various types such as LTE-A (LTE-Advanced), LTE-A Pro (LTE-Advanced Pro), and EUTRA (Evolved Universal Terrestrial Radio Access). When described as LTE, these types are also included in LTE. Similarly, NR includes meanings such as NRAT (New Radio Access Technology) and FEUTRA (Further EUTRA), for example. A base station is also called an eNodeB (evolved NodeB) in LTE, and is also called a gNodeB in NR. In LTE and NR, a communication terminal is also called UE (User Equipment). In addition, NR is a technical framework that is being studied to support usage scenarios, requirements, deployment scenarios, and the like in various use cases such as eMBB (Enhanced mobile broadband), mMTC (Massive machine type communications), and URLLC (Ultra reliable and low latency communications).

In the present disclosure, a radio link from the communication terminal 11 to the base station device 12 is referred to as an uplink, and a radio link from the base station device 12 to the communication terminal 11 is referred to as a downlink. Data wirelessly transmitted from the communication terminal 11 reaches the base station device 12 via an uplink. Wireless transmission via an uplink is also referred to as uplink transmission, and wireless transmission via a downlink is also referred to as downlink transmission.

In order to start wireless communication between the communication terminal 11 and the base station device 12, the communication terminal 11 and the base station device 12 need to be synchronized by adjusting timing advance values. The adjustment of the timing advance value for the uplink of the base station device 12 is referred to as uplink synchronization. On the other hand, the adjustment of the timing advance value for the downlink of the communication terminal 11 is referred to as downlink synchronization. In general, the base station device 12 periodically transmits a signal used for downlink synchronization, such as system information, and the communication terminal 11 receives the signal to recognize the base station device 12 and performs downlink synchronization. Conventionally, the communication terminal 11 uplink-transmits a signal that can be used for uplink synchronization, such as a preamble, using a predetermined channel for the signal, such as a PRACH (Physical Random Access Channel), according to a random access procedure or the like.

However, the communication terminal 11 of the present embodiment may uplink-transmit data from the beginning using a predetermined channel for data transmission, such as a PUSCH (Physical Uplink Shared Channel), without transmitting a preamble. By doing so, the communication terminal 11 can start data transmission immediately after receiving the downlink synchronization signal from the base station device 12, and the time required to start data transmission is shortened.

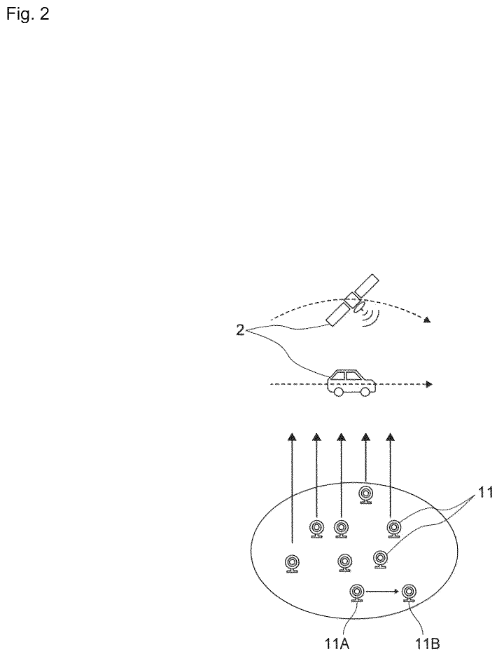

FIG. 2 is a diagram showing an arrangement example of the base station device 12. In the example of FIG. 2, the base station device 12 is provided in the mobile base station 2. When the mobile base station 2 is constantly moving, the communication terminal 11 can transmit data to the base station device 12 only while the mobile base station 2 exists within the communication range of the communication terminal 11. That is, the time during which the communication terminal 11 can transmit data to the base station device 12 is limited. As shown in FIG. 2, when a large number of communication terminals 11 attempt to transmit data to the base station device 12 at substantially the same time, connection failures and long delays may occur. Therefore, it takes time to transmit data, and the mobile base station 2 may move out of the communication range of the communication terminal 11 before the data transmission is completed, and the data transmission may fail. However, if the time required to start data transmission is reduced as in the present disclosure, the completion time of data transmission can be shortened, and such a situation can be prevented as much as possible.

Although the base station device 12 is provided in the mobile base station 2 in the example of FIG. 2, it may be provided in a fixed base station. Even if the base station device 12 does not move, by starting data transmission without waiting for uplink synchronization of the base station device 12, it is possible to obtain the advantage of shortening the completion time of data transmission.

However, without uplink synchronization, the base station device 12 cannot decode data transmitted uplink. Therefore, the base station device 12 of the present embodiment does not rely on conventional signals for uplink synchronization such as preambles, but uses signals transmitted on PUSCH such as reference signals and cyclic prefixes to perform uplink synchronization.

Even if uplink synchronization is performed using a reference signal or the like, the synchronization point will shift, and the accuracy of channel estimation will decrease. To solve this problem, the present embodiment also changes the method of uplink transmission on PUSCH.

In the above description, the case where the communication terminal 11 and the base station device 12 start wireless communication is taken as an example. However, the wireless communication method of the present disclosure can be used in situations where the communication terminal 11 and the base station device 12, in which uplink synchronization is required, have not established wireless communication connection. In addition to the case of starting wireless communication, the wireless communication method of the present disclosure can be used even when trying to shift again to a state in which communication connection is established, such as RRC Connected, from a state communication connection is not established, which is called Radio Resource Control (RRC) Idle, RRC Inactive, or the like in LTE or NR, for example.

In the example of FIG. 1, wireless communication between the communication terminal 11 and the base station device 12 is assumed, but the wireless communication method of the present disclosure may be implemented in wireless communication between the communication terminals 11. Although FIG. 2 shows the first communication terminal 11A and the second communication terminal 11B, the wireless communication method of the present disclosure may also be used for data wireless transmission from the first communication terminal 11A to the second communication terminal 11B. In that case, the communication terminal 11 may be read as the first communication terminal 11A, the base station device 12 may be read as the second communication terminal 11B, uplink transmission from the communication terminal 11 to the base station 2 may be read as sidelink transmission from the first communication terminal 11A to the second communication terminal 11B, and downlink transmission from the base station 2 to the communication terminal 11 may be read as sidelink transmission from the second communication terminal 11B to the first communication terminal 11A. That is, the first communication terminal 11A transmits data to the second communication terminal 11B without transmitting a signal for sidelink synchronization to the second communication terminal 11B, and the communication terminal 11B may perform sidelink synchronization using a reference signal, a cyclic prefix, or the like received together with the data.

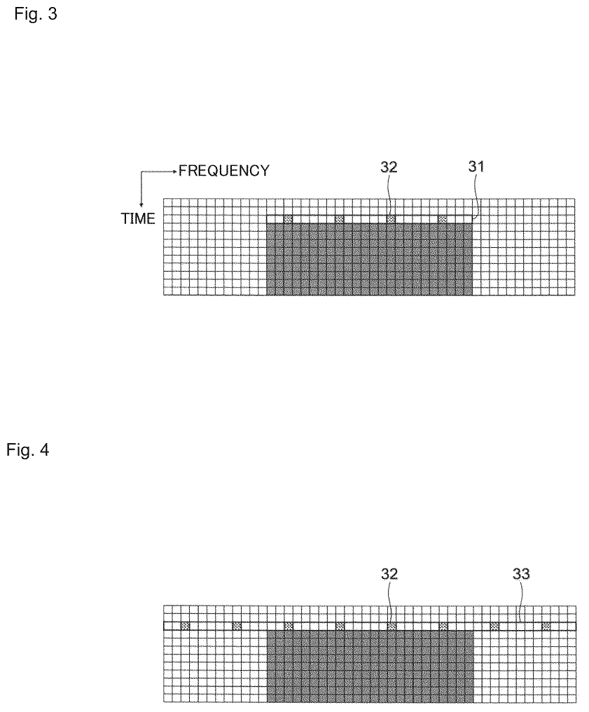

Uplink transmission on PUSCH is described. FIG. 3 is a diagram showing a first example of a conventional resource grid. In wireless communication technologies such as OFDMA (Orthogonal Frequency Division Multiple Access) and NOMA (Non-Orthogonal Multiple Access) adopted in NR and the like, a radio frame is composed of a plurality of subframes, and the subframe is composed of the smallest units called resource elements. Each rectangle surrounded by grid lines shown in FIG. 3 corresponds to a resource element. Frequency and time are allocated in order to the resource element. In the example of FIG. 3, the horizontal axis means frequency and the vertical axis means time. The entire horizontal width of the resource grid, that is, the frequency width (frequency band) corresponds to a component carrier, Band Width Part (BWP), or the like, and the horizontal width of the resource element, that is, the frequency width corresponds to a subcarrier.

In uplink transmission on PUSCH, not only data but also reference signals and the like are transmitted, and each frequency for transmitting data, reference signals and the like are designated on the basis of a resource element. For example, a resource element group painted in black in FIG. 3 is resource elements allocated for data transmission. Therefore, the communication terminal 11 transmits data in the frequency band corresponding to the resource element group in the time width corresponding to the resource element group. A resource element group in which a plurality of adjacent resource elements is collected in this way is called a resource block. Data is typically allocated in units of resource blocks. On the other hand, four resource elements 32 present in a range 31 surrounded by a bold frame and represented by dot patterns are resource elements allocated for transmission of reference signals. In order to avoid interference, reference signals are usually allocated at intervals, not in units of resource blocks but in units of resource elements.

Although it will be described later, more specifically, a range of resource elements that can be allocated for the reference signal is designated as the range 31, and which resource element will be used in the range is determined depending on the number of antenna ports that the communication terminal 11 has. In other words, one or more resource elements are selected from the designated range 31. Therefore, the range 31 is also described as a selectable range.

In the present embodiment, in order to prevent deterioration of the accuracy of channel estimation, the selectable range of resource elements that can be used for transmission of signals used for channel estimation is changed. By changing the selectable range, the degree of freedom in determining the frequencies used for transmission of the signal is increased. For example, the upper and lower limits of the frequencies used for transmission of the signal can be changed. For example, the number of the signals, the frequency interval of the signals, and the like can be changed.

In FIGS. 4 to 8, as an example, reference signals are used for channel estimation, and the range of resource elements that can be used for transmission of reference signals is changed. When using another signal such as a cyclic prefix, the selectable range of resource elements that can be used for the other signal may be similarly changed.

FIG. 4 is a diagram showing a first example of a resource grid according to the present embodiment. The range 33 surrounded by a bold frame is a selectable range in the example of FIG. 4. The range 33 is extended in the frequency axis direction more than the range 31. That is, the frequency range that can be used for transmission of reference signals has been extended compared to the conventional technique. In the example of FIG. 4, eight resource elements are selected from the range 33 at regular intervals. Although the interval of resource elements is the same as in the example of FIG. 3, more resource elements can be selected than in the example of FIG. 3 because the selectable range has been extended. Since the intervals between resource elements are the same, the degree of interference is the same. However, since the number of resource elements is large, more reference signals can be transmitted, so the accuracy of channel estimation in the example in FIG. 4 is higher than in the example in FIG. 3.

The condition for determining whether to extend the selectable range, in other words, the condition for switching the frequency band that can be used for transmission of reference signals may be determined in advance. For example, the selectable range may be extended when uplink synchronization is not performed, and the selectable range may not be extended when uplink synchronization is performed. If the uplink bandwidth is narrower than a comparison target such as a component carrier, BWP, or FFT size, the selectable range may be extended. Further, the conditions may be on the basis of information unique to the communication terminal 11 such as International Mobile Subscriber Identity (IMSI). Alternatively, the conditions may be on the basis of information on wireless communication such as transmission time (symbol, slot, subframe, frame, radio frame, or the like), transmission band (subcarrier, resource block, BWP, component carrier, or the like).

The base station device 12 may determine whether to use the extended range. In that case, the base station device 12 may insert an instruction as to whether to extend the selectable range in system information, RRC signaling, or the like, and the communication terminal 11 may follow the instruction.

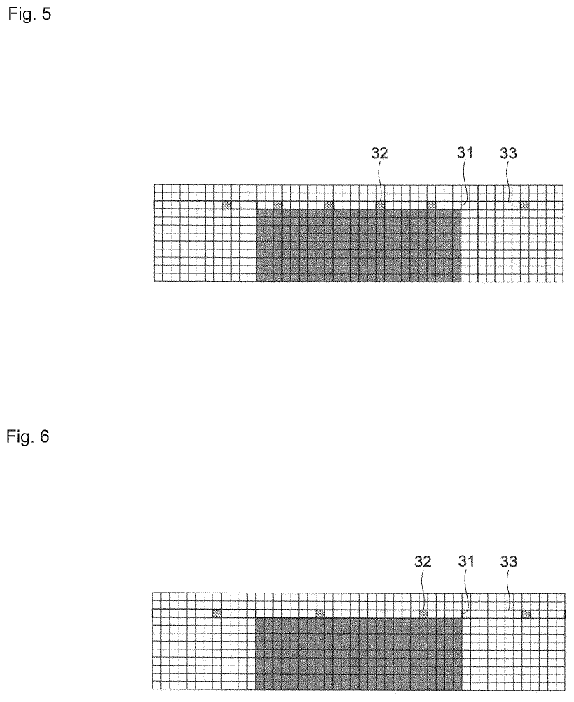

In the example of FIG. 4, eight resource elements are selected from the range 33 at regular intervals, but the same resource elements may not always be selected. FIG. 5 is a diagram showing a second example of a resource grid according to the present embodiment. In the example of FIG. 5, six resource elements are selected unlike the example of FIG. 4. The positions of the selected resource elements are different from the example in FIG. 4. Thus, the number, positions, or the like of resource elements to be selected may be changed as appropriate.

Alternatively, the resource elements selected from the unextended normal selectable range may be fixed, and the resource elements selected from the extended portion of the selectable range may not be fixed. In the example of FIG. 5, the resource elements selected from the range 31, which is the normal selectable range, are the same as in the examples of FIGS. 3 and 4. On the other hand, the resource elements selected from the extended portion of the selectable range, in other words, the resource elements selected from within the range 33 outside the range 31 are different from the example in FIG. 4.

Widening the interval between selected resource elements is also effective in improving the accuracy of channel estimation. FIG. 6 is a diagram showing a third example of the resource grid of the present embodiment. Four resource elements are selected in the example of FIG. 6, which is the same number as in the example of FIG. 4. However, since the resource elements are selected from the range 33 obtained by extending the selectable range, the intervals between the selected resource elements are wider than in the example of FIG. 4. In this way, the effect of momentary channel quality degradation can be avoided since the intervals between the frequencies used for transmission are lengthened.

If the selectable range is extended, resource elements allocated for another communication terminal may be selected. Therefore, it is preferable that the resource elements existing in the extended portion of the selectable range be less likely to be selected than the resource elements existing in the unextended portion of the selectable range. Therefore, for example, a condition may be defined such that the number of resource elements selected from the extended portion of the selectable range is less than the number of resource elements selected from the unextended portion of the selectable range. Alternatively, an antenna port different from the antenna port allocated for another communication terminal in the extended portion of the selectable range may be used in the extended portion of the selectable range.

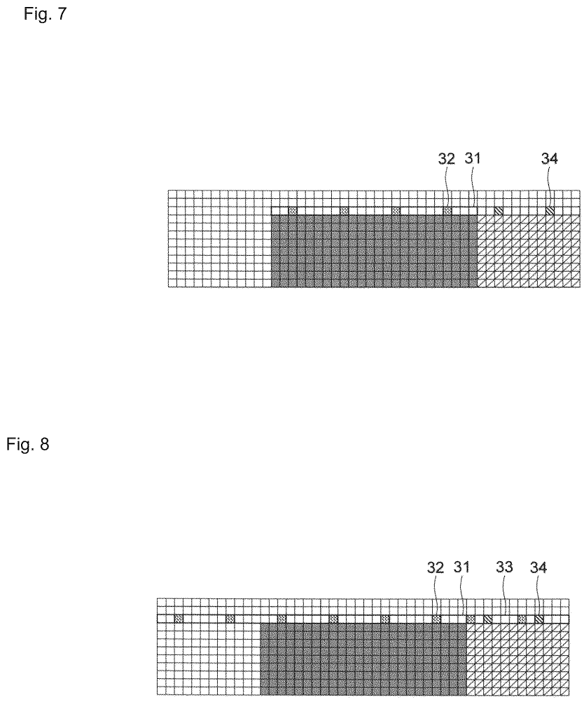

Alternatively, resource elements allocated for another communication terminal may be made unselectable. FIG. 7 is a diagram showing a second example of a conventional resource grid. Resource elements with a right diagonal line are resource elements allocated for data transmission of another communication terminal. A resource element 34 with left diagonal lines is a resource element allocated for transmission of reference signals of another communication terminal. In the example shown in FIG. 7, if the communication terminal 11 extends the selectable range and selects resource elements at the same interval, the resource element 34 is selected, and collision of reference signals, that is, interference occurs. Therefore, it is preferable to prevent the selection of resource elements allocated for another communication terminal. Not only resource elements allocated for another communication terminal but also resource elements around the resource elements allocated for the other communication terminal may not be selected.

FIG. 8 is a diagram showing a fourth example of the resource grid according to the present embodiment. In the example of FIG. 8, resource elements are selected at regular intervals as in the example of FIG. 4. However, since the resource element 34 allocated for another communication terminal is selected as it is, the resource element to be selected is shifted.

If there are resource elements that are not selected, it is the same as the extended selectable range being divided into a plurality of ranges. In other words, the extended selectable range may be composed of a plurality of discontinuous ranges.

In the examples of the drawings so far, the selectable range has been extended in both the increasing direction and the decreasing direction in the frequency direction, but it may be extended in either direction only. Since at least one of the resource elements present in the extended portion of the selectable range is selected, the reference signal can be transmitted using at least one frequency outside of the frequency range that can be used when the selectable range is not extended.

The method of selecting resource elements from the extended selectable range may be determined as appropriate, but may be determined in advance depending on the communication scheme. For example, for DM-RS (Demodulation Reference Signal), which is one of the reference signals used in NR, the position of the resource element is calculated on the basis of the following formula, and the resource element at that position is selected.

$${α}_{k , l}^{\% ( {p}_{j}^{\%} , μ )} = {w}_{f} ( {k}^{′} ) {w}_{t} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2\end{matrix} \\ {k}^{′} = 0 , 1 \\ l = \overline{l} + {l}^{′} \\ n = 0 , 1 , … \\ j = 0 , 1 , … , v - 1 \qquad [ Math . 1 ]$$

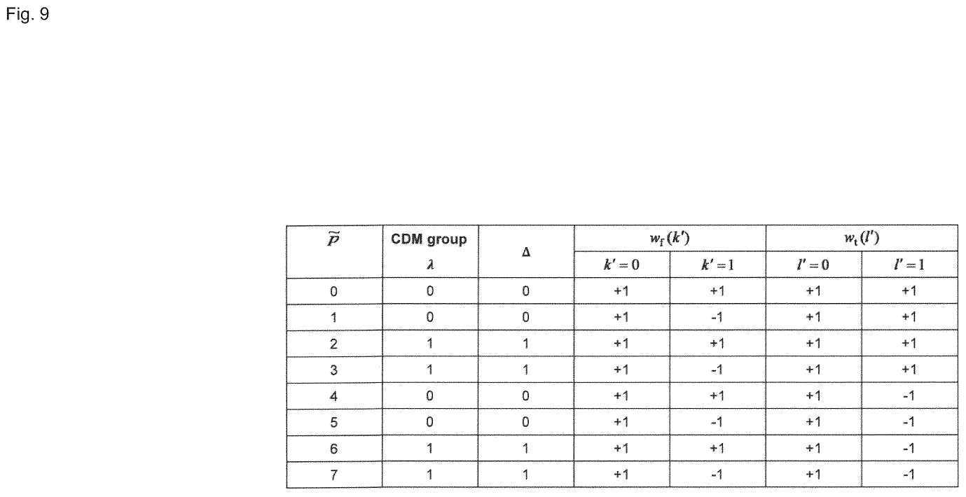

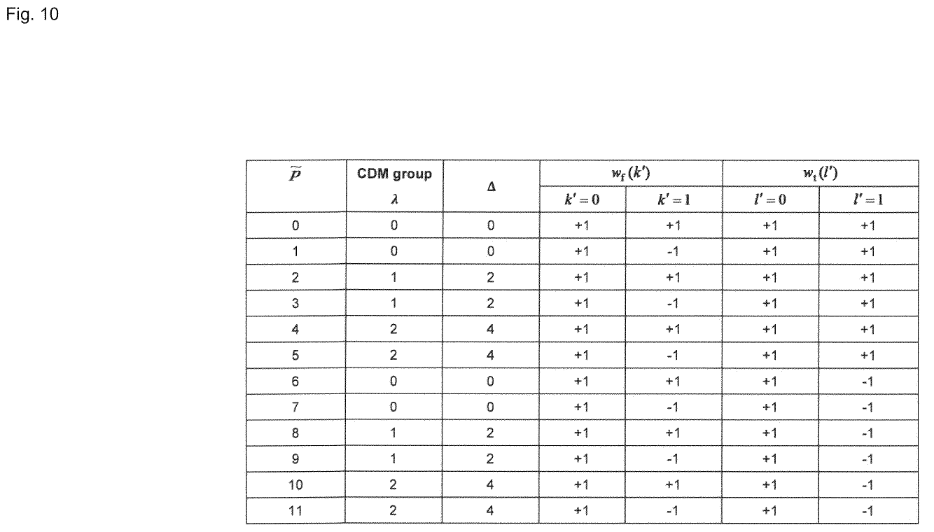

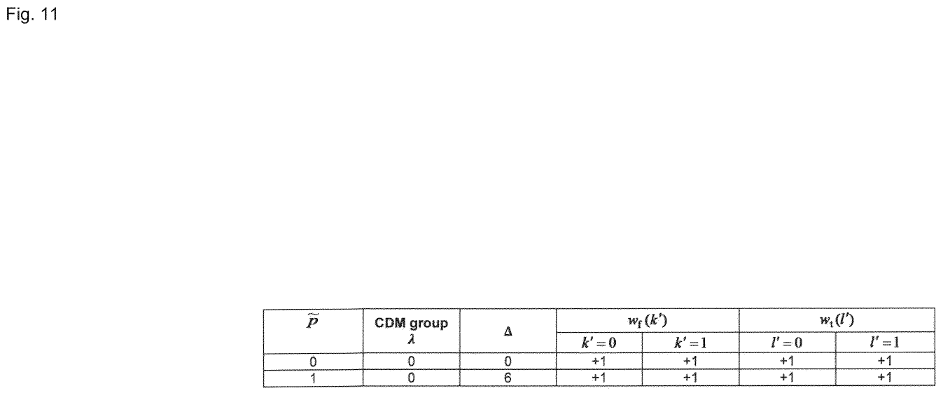

The following conditions are fulfilled:
the resource elements ã_{k,l}^{(\tilde{p}}^{ⱼ}^{,μ)} are within the common resource blocks allocated for PUSCH transmission.
   Here, r(m) represents a sequence of reference signals, and ã_{k,l}^{%(p}^{ⱼ}^{^{%}}^{,μ)} represents reference signals mapped to physical resources. k is the index on the frequency axis and l is the index on the time axis. It is also assumed that resource elements ã_{k,l}^{(\tilde{p}}^{ⱼ}^{,μ)} exist within a shared resource block allocated for PUSCH. Other parameters differ depending on the Configuration Type. FIG. 9 shows parameter values for Configuration type 1, and FIG. 10 shows parameter values for Configuration type 2.

On the other hand, when the selectable range is extended as in the present embodiment, the above formula may be changed as follows.

$${α}_{k , l}^{\% ( {p}_{j}^{\%} , μ )} = {w}_{f} ( {k}^{′} ) {w}_{t} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2 \\ 12 n + Δ & Configuration type 3\end{matrix} \\ {k}^{′} = 0 , 1 \\ l = \overline{l} + {l}^{′} \\ n = 0 , 1 , … \\ j = 0 , 1 , … , v - 1 \qquad [ Math . 2 ]$$

If transmission without timing advance adjustment, the resource element ã_{k,l}^{(\tilde{p}}^{ⱼ}^{,μ)} which is defined as configuration type 3 are external the common resource blocks allocated for PUSCH transmission.
   Resource elements existing outside the common resource block allocated for PUSCH transmission are defined as Configuration type 3. If the transmission is performed without prior uplink synchronization, the resource elements ã_{k,l}^{(\tilde{p}}^{ⱼ}^{,μ)} defined as Configuration type 3 are selected. FIG. 11 shows parameter values for Configuration type 3. Here, the formula shown in Configuration Type 3 is an example, and may be a formula other than this example to which the present invention is applicable.

Information for performing the above processing, such as the resource grid, the selectable range, the determination conditions for changing the selectable range, the range after extension of the selectable range, and the resource element selection method, may be stored in the storage unit 111 of the communication terminal 11 in advance. The information may be periodically transmitted from the base station device 12 in the same manner as the signal used for downlink synchronization so that the communication terminal 11 can acquire the information. For example, information about the configuration of the reference signal, such as the configuration type of the reference signal, the antenna port index, or the reference signal transmission resource information, may be transmitted downlink. For example, information on transmission resources, and information such as modulation scheme, code rate, number of layers, transmission weight, or the like may be transmitted downlink.

As described above, the base station device 12 may send a notification to the communication terminal 11 to instruct extension of the selectable range. For example, when communication terminal 11 that is not in a wireless connection state transmits data on PUSCH without extending the selectable range, a notification may be sent so that the base station device 12 extends the selectable range.

In this way, reference signals are transmitted on frequencies corresponding to a plurality of selected resource elements at the same time corresponding to the plurality of selected resource elements. In other words, reference signals are transmitted to the base station device 12 on the plurality of selected frequencies at the same timing.

The channel estimation method by the base station device 12 can be performed, for example, from autocorrelation of reference signals. Alternatively, a method may be applied in which a discrete Fourier transform (IDFT) is applied to the reference signal to transform it into the time domain and then re-transform it into the frequency domain.

As for the method of estimating the reception timing, for example, the reception timing may be directly estimated from the impulse response based on the correlation between the reference signal from the communication terminal 11 and the reception signal received by the base station device 12. In the impulse response, for example, a range from the maximum peak of the correlation output with the reference signal to a predetermined number of previous samples is selected as a search range, and, in the search range, paths of samples whose peaks are greater than or equal to a predetermined ratio of the maximum peak may be selected. With such a search range, it is possible to prevent timing determination from being delayed even when the maximum peak does not correspond to the leading path. When there is a plurality of communication terminals 11, the base station device 12 may estimate the impulse response as described above for each estimated communication terminal 11, and use the beginning of the user's impulse response as the reception timing of each communication terminal.

The values of the predetermined number and the predetermined ratio described above may be determined in advance on the basis of wireless communication specifications or the like. When performing sidelink transmission between the communication terminals 11, the base station device 12 may transmit these values to the communication terminals 11.

Even if the resources to be used are designated by the base station device 12 after the communication terminal 11 starts uplink transmission, there is no problem because the time required to start data transmission is shortened. For example, the base station device 12 may notify of resources to be used in RRC signaling or the like.

Non-Orthogonal Multiple Access (NOMA) that can be used for wireless communication according to the present embodiment will be described.

In Orthogonal Multiple Access (OMA) transmission, such as OFMDA, wireless communication is performed on the basis of two orthogonal parameters, frequency and time. The configuration of a radio frame is determined by the intervals of subcarriers in wireless communication, and it is not possible to use more resources than the resources (range of parameters) allocated for resource elements made available in wireless communication. On the other hand, in NOMA transmission, a frame configuration is determined by adding non-orthogonal axes such as the interleave pattern axis, the spreading pattern axis, the scrambling pattern axis, the codebook axis, and the power axis as parameter axes, in addition to the orthogonal frequency and time axes.

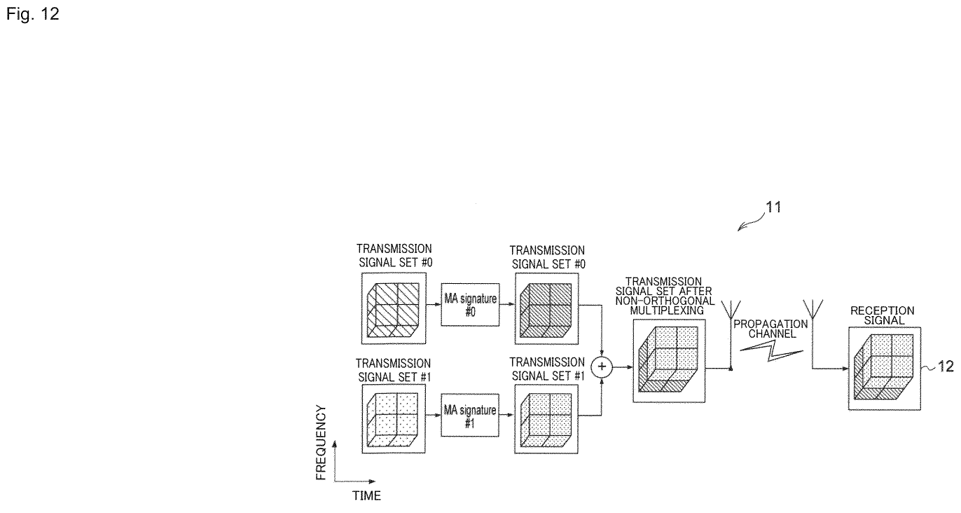

FIG. 12 is a diagram showing a first example of NOMA transmission. In the example of FIG. 12, two transmission signal sets, transmission signal sets #0 and #1,are multiplexed. Three or more transmission signal sets may be multiplexed. The transmission destinations of the respective transmission signal sets may be the same or different.

A corresponding Multiple Access (MA) signature is applied to each of the two transmission signal sets. The MA signature is a non-orthogonal axis resource, and may be, for example, Interleave pattern, Spreading Pattern, Scrambling Pattern, Codebook, Power Allocation, Repetition, or the like. The MA signature is also simply referred to as Pattern or Index, and may mean identifiers such as Pattern and Index used in NOMA transmission, or it may mean Pattern itself.

Two transmission signal sets to which the MA signature is applied are multiplexed with the same resource on the orthogonal axes. Here, orthogonal-axis resources are frequency (frequency resource) and time (time resource). Two transmission signal sets are shown overlapping because they were multiplexed with the same resource on the orthogonal axes but resources on the non-orthogonal axes are different. The multiplexed transmission signal set is wirelessly transmitted via the same antenna port.

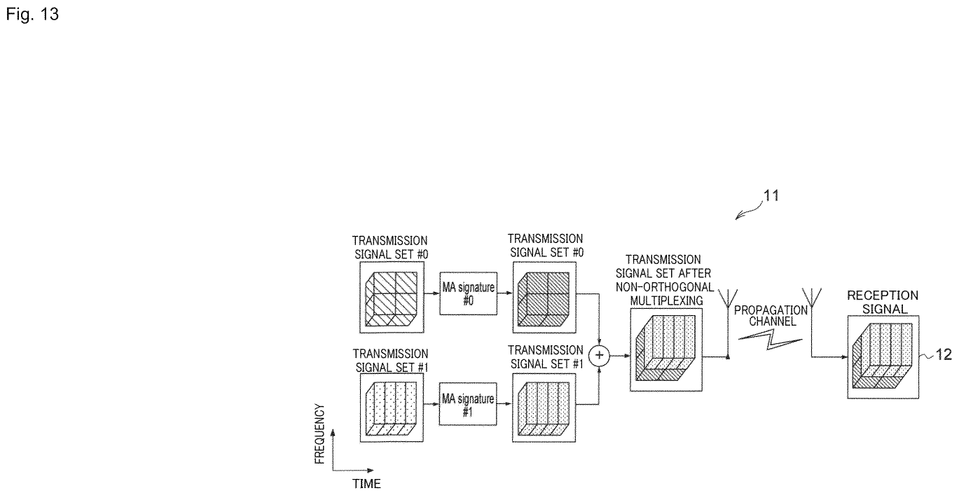

FIG. 13 is a diagram showing a second example of NOMA transmission. Transmission signal sets #0 and #1 are the same parameter set in the example of FIG. 12, but transmission signal sets #0 and #1 are different parameter sets in the example of FIG. 13. Other than that point, the example is the same as the example in FIG. 12. In this way, transmission signal sets with different parameter sets may be NOMA-transmitted.

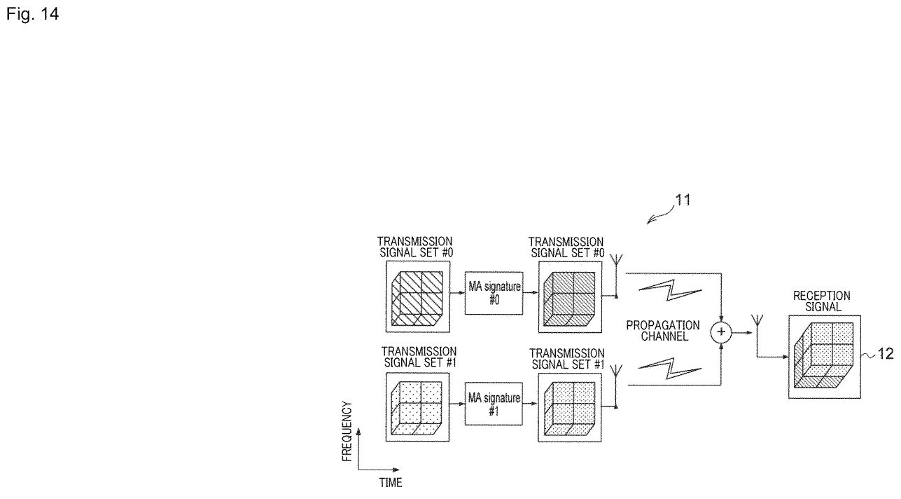

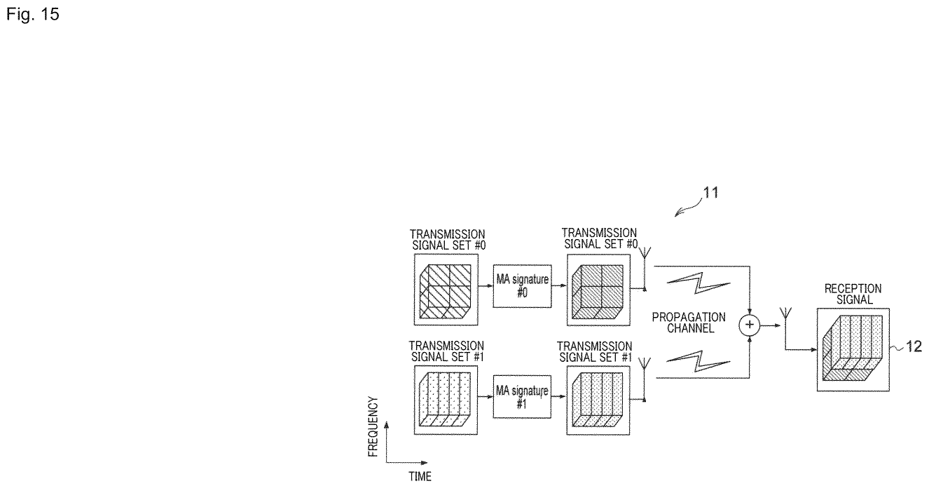

On the other hand, a method is also conceivable in which a signal to which the MA signature is applied is wirelessly transmitted without multiplexing so that non-orthogonal multiplexing is performed on the propagation channel. FIGS. 14 and 15 are diagrams showing third and fourth examples of NOMA transmission, respectively. Transmission signal sets #0 and #1 are the same parameter set in the example of FIG. 14, but transmission signal sets #0 and #1 are different parameter sets in the example of FIG. 15. In the examples of FIGS. 14 and 15 as well, a corresponding MA signature is applied to each transmission signal set as in the previous examples. However, signals to which the MA signature is applied are transmitted using the same frequency resource and time resource without being multiplexed, and are multiplexed on the propagation channel. In the examples of FIGS. 14 and 15, the transmission signal sets #0 and #1 may be transmitted from separate communication terminals because multiplexing is performed on the propagation channel.

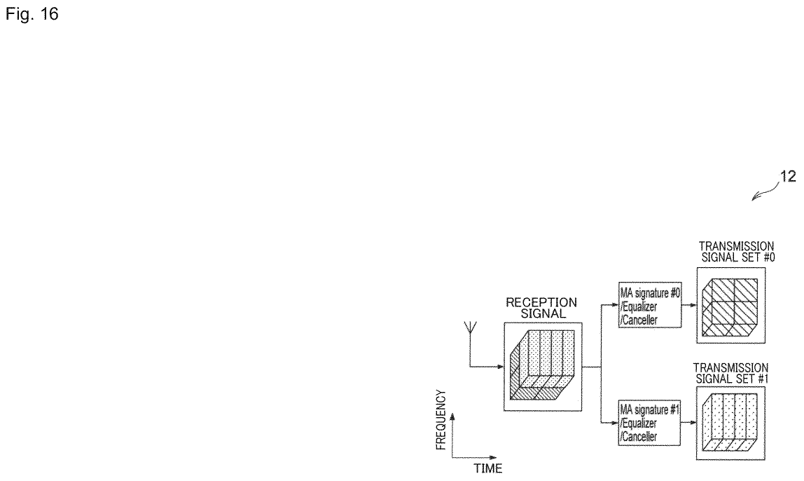

FIG. 16 is a diagram showing a fifth example of NOMA transmission. In FIG. 16, the decoding of data transmitted using NOMA is shown. As described above, in NOMA transmission, a plurality of transmission signals is multiplexed and transmitted on the same frequency resource and time resource. Therefore, channel equalization and interference signal cancellation are performed using the MA signature applied before multiplexing to decode the multiplexed transmission signal set. Therefore, the applied MA signature needs to be shared by both sender and receiver.

If the same MA signature is used for multiplexing, since the influence of interference between multiplexed signals increases, it is difficult to decode the signals. Therefore, in NOMA transmission, different MA signatures need to be applied for the multiplexed transmission signal sets.

The MA signature used for NOMA transmission may be included as one of the resources used for wireless communication in the present embodiment. AMA signature value may be assigned to a resource element. Three resources including frequency, time, and MA signature may be referred to as a Multiple Access (MA) resource. The resources including only frequency and time may also be referred to as a Multiple Access (MA) Physical resource. Non-orthogonal multiplex communication may be used in the configuration of the present embodiment as described above.

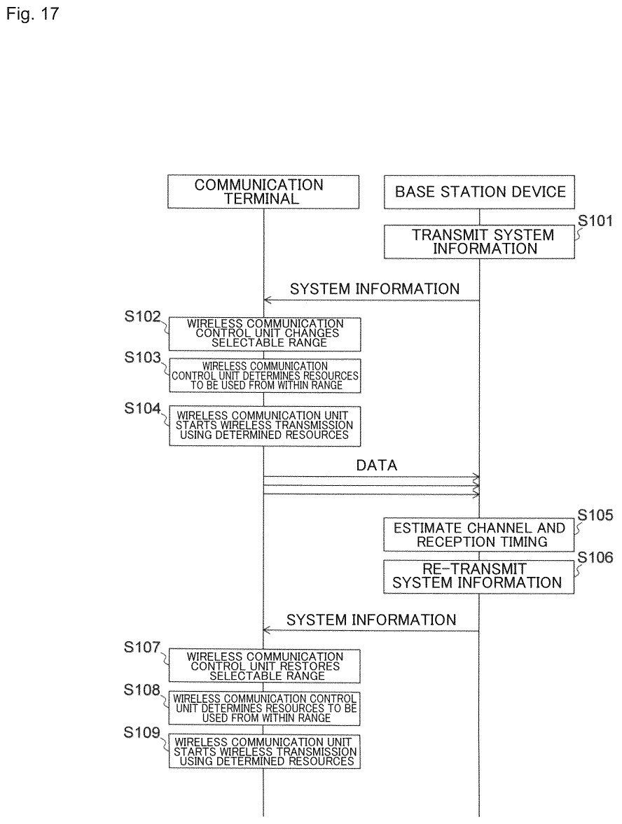

Next, processing of the components of the communication terminal 11 and its flow will be described. FIG. 17 is a diagram showing an example of a wireless communication sequence between the communication terminal 11 and the base station device 12. The example of FIG. 17 shows the processing in the initial connection. Each step of processing is not necessarily performed according to this sequence. The base station device 12 may perform the processing shown in this sequence simultaneously with another communication terminal.

The base station device 12 transmits wireless communication such as system information to the communication terminal 11 (S101), and the wireless communication unit 113 of the communication terminal 11 receives the wireless communication. The system information may include instructions regarding data transmission of the communication terminal 11. For example, information may be included that instructs a change in the selectable range of resource elements. For example, information about available or unavailable antenna ports may be included. In addition, information irrelevant to changes in the selectable range, such as information on transmission resources, modulation scheme, code rate, number of layers, and transmission weight, may be included.

When the wireless communication control unit 112 of the communication terminal 11 considers performing wireless communication using PUSCH instead of PRACH, and determines to transmit data using PUSCH, the wireless communication control unit 112 considers changing the selectable range of resource elements used for data transmission based on predetermined conditions (S102). When starting wireless communication with a specific communication counterpart such as the base station device 12, it may be determined to perform wireless communication using PUSCH. In the example of FIG. 17, it is assumed that the selectable range is changed from the normal range. The wireless communication control unit 112 determines the wireless resources to be used by selecting resource elements from within the changed selectable range (S103).

As described above, the normal selectable range, the extended selectable range, the method of changing the selectable range, the conditions for changing the selectable range, the method of selecting resource elements, and the like may be stored in the storage unit 111 in advance, and the wireless communication control unit 112 may acquire these pieces of information from the storage unit 111 in the processing of S102. Alternatively, the wireless communication unit 113 may acquire these pieces of information from the system information transmitted from the base station.

The wireless communication unit 113 of the communication terminal 11 performs wireless transmission using the resources determined by the wireless communication control unit 112 (S104). Since the wireless transmission is performed on PUSCH, and in the example of FIG. 17, the selectable range is changed, the reference signal is also transmitted on a frequency that is not normally used. As shown in FIG. 17, no signal for uplink synchronization such as a preamble is transmitted before data transmission. Due to this, the initial connection process becomes simpler than the conventional technique.

The wireless communication control unit 112 may determine to establish wireless connection using the PRACH. In that case, the wireless communication unit 113 may transmit a signal such as a preamble on PRACH as in the conventional case.

The base station device 12 performs channel estimation and reception timing estimation (S105). Since the reference signal is transmitted on a frequency outside of the normal frequency range, deterioration in the estimation accuracy is suppressed.

After performing channel estimation and reception timing estimation, the base station device 12 may transmit system information to the communication terminal 11 again. The system information may be re-transmitted periodically or non-periodically. In the example of FIG. 17, the system information is re-transmitted to restore the selectable range (S106).

Upon re-receiving the system information, the wireless communication control unit 112 determines whether to change the selectable range again. In the example of FIG. 17, since the system information includes an instruction to restore the selectable range, the wireless communication control unit 112 restores the selectable range to the original unextended range (S107). Then, the wireless communication control unit 112 determines the resource to be used from the unextended selectable range (S108), and the wireless communication unit 113 starts wireless transmission using the determined resource (S109). In this way, wireless transmission in the normal frequency range may be performed.

An evaluation of the processing of the present embodiment will be described. In order to evaluate the processing of the present embodiment, simulations were performed with and without extending the selectable range of the reference signal. In the case of no extension, resource elements were selected as shown in FIG. 3. In the case of extension, resource elements were selected as shown in FIG. 6. The reference signal interval is 6 subcarrier intervals in FIG. 3, whereas the reference signal interval is 12 subcarrier intervals in FIG. 6. Thus, the number of reference signal subcarriers when the selectable range of reference signals was extended is not increased from the number of reference signal subcarriers when the selectable range of reference signals was not extended.

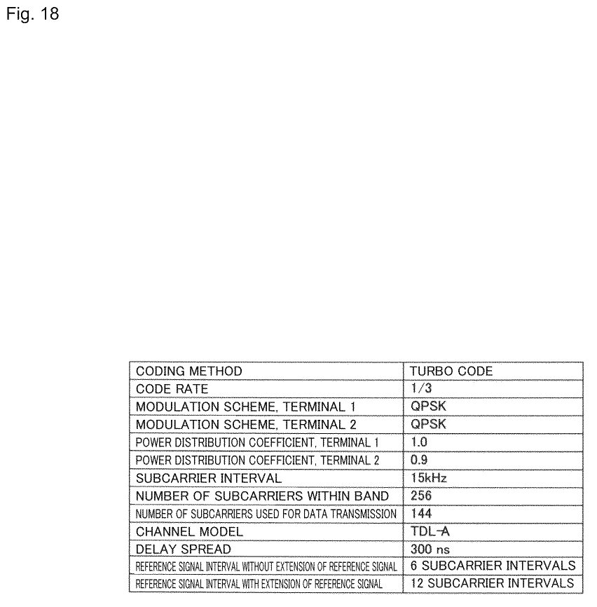

In this simulation, the communication terminal 11 performed non-orthogonal multiplexed uplink transmission on the power axis, and the base station device 12 performed decoding after synchronizing the asynchronously transmitted uplink signals. In both cases, it was assumed that there was no reception timing offset between uplink signals. FIG. 18 is a diagram showing simulation conditions, and shows other simulation conditions.

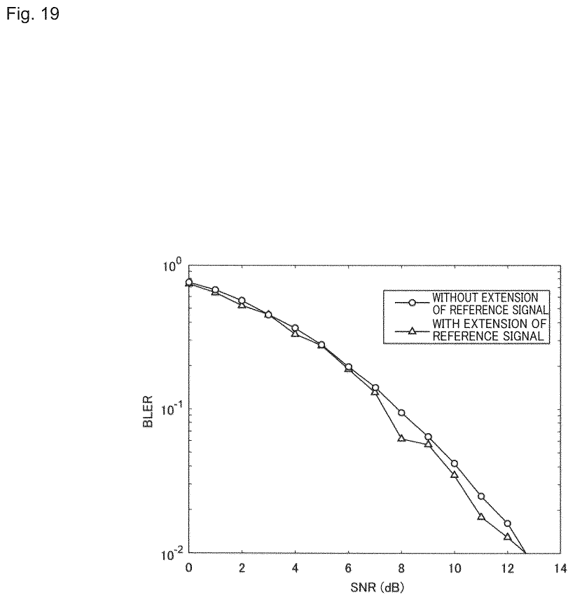

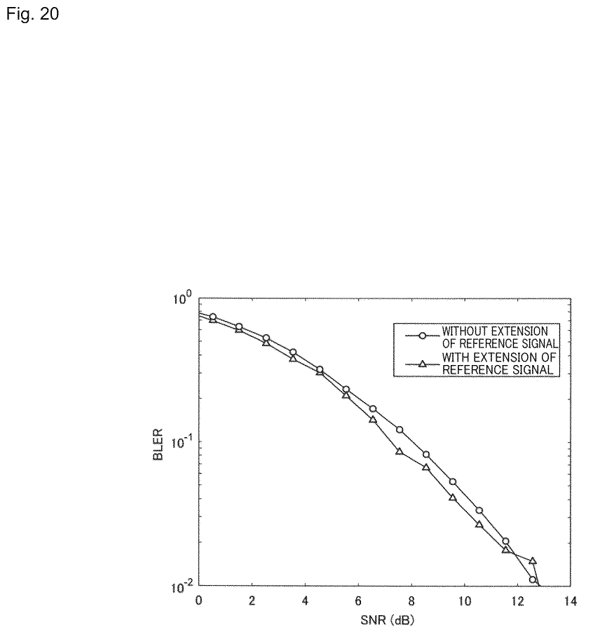

FIGS. 19 and 20 are diagrams for explaining simulation results. The communication terminals to be evaluated are different between the simulation in FIG. 19 and the simulation in FIG. 20. FIGS. 19 and 20 show graphs showing the relationship between error rate characteristics and reception SNR (Signal to noise ratio). In these figures, the horizontal axis indicates reception SNR (dB), and the vertical axis indicates BLER (Block Error Rate), which is an error rate. In both FIGS. 19 and 20, the graphs for the extended case are below the graphs for the unextended case at most SNRs. In this way, the wireless communication method of the present disclosure, in which the selectable range is extended and the reference signal transmission method is changed, can suppress BLER at a low level.

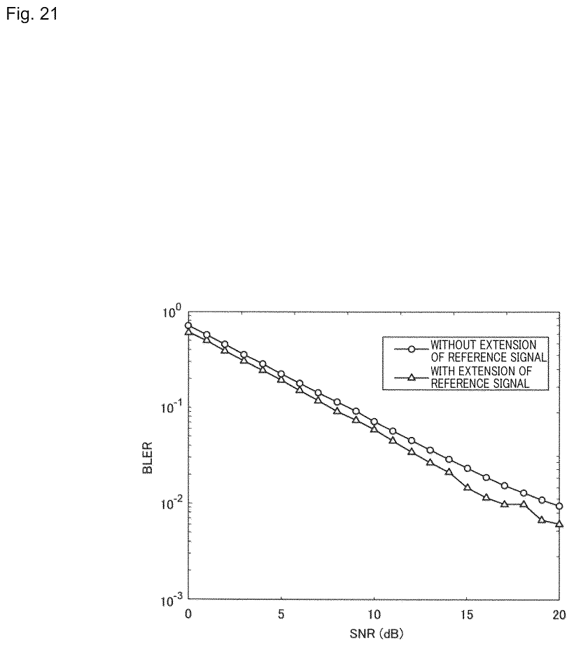

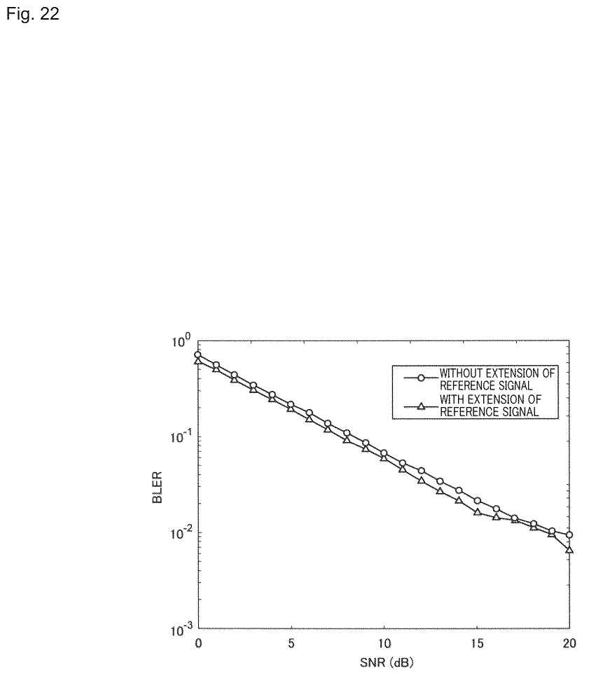

FIGS. 21 and 22 are diagrams for explaining another simulation result. These figures also show graphs showing the relationship between error rate characteristics and reception SNR, and mean square error (MSE) is used as the error characteristics. The communication terminals to be evaluated are different between the simulation in FIG. 21 and the simulation in FIG. 22. In both FIGS. 21 and 22, the graphs for the extended case are below the graphs for the unextended case at all SNRs. Therefore, it is clear that the wireless communication method of the present disclosure improves the channel estimation accuracy even in the mean squared error verification.

Therefore, if the wireless communication method of the present disclosure is used, even when the communication terminal 11 starts uplink transmission on a channel for transmitting data such as PUSCH rather than a channel for wireless communication connection such as PRACH in a state where wireless communication connection is not established, the base station device 12 can sufficiently perform channel estimation and reception timing estimation from reference signals and the like.

As described above, in the present embodiment, data can be uplink-transmitted from the beginning using a predetermined channel for data transmission, such as PUSCH (Physical Uplink Shared Channel), without transmitting a preamble even in a state where wireless connection is not established. By doing so, data transmission can be started immediately after receiving a downlink synchronization signal, and the time required to start data transmission is shortened.

Further, in the present embodiment, the selectable range of resource elements allocated for reference signals and the like is extended, and resource elements are selected from the extended portion of the selectable range. As a result, even if part of the uplink synchronization processing, which is the initial processing of wireless communication connection, is omitted, the decrease in channel estimation accuracy can be suppressed to some extent. It is possible to reduce the risk of data transmission failure even in wireless transmission in which communication time is limited.

It should be noted that the above-described embodiments show examples for embodying the present disclosure, and the present disclosure can be implemented in various other forms. For example, various modifications, substitutions, omissions, or combinations thereof are possible without departing from the gist of the present disclosure. Such forms of modifications, substitutions, and omissions are included in the scope of the invention described in the claims and the scope of equivalence thereof, as included in the scope of the present disclosure.

The procedures of processing described in the present disclosure, such as the communication sequence described above, may be regarded as a method having a series of procedures. Alternatively, the series of procedures may be regarded as a program to be executed by a computer having a circuit or processor, or a recording medium storing the program. Since the type of the recording medium does not affect the embodiments of the present disclosure, the type is not particularly limited.

The present disclosure may have the following configuration.

[1]

A communication device including:
a determination unit that determines, upon receiving wireless communication from a communication counterpart with which wireless communication connection is not established, to perform wireless communication on a first channel for transmitting data with the communication counterpart; and
a wireless communication unit that transmits wireless communication on the first channel to the communication counterpart when it is determined to perform wireless communication on the first channel.

[2]
The communication device according to [1], wherein
when it is determined to perform wireless communication on the first channel, the determination unit determines to extend a frequency range in the first channel, the frequency range determined in advance to be allocatable for transmission of a first signal included in the wireless communication transmitted to the communication counterpart,
the determination unit determines a frequency to be allocated for transmission of the first signal in the extended frequency range, and
the wireless communication unit transmits the first signal on the frequency determined to be allocated for transmission of the first signal in the wireless communication with the communication counterpart on the first channel.

[3]

The communication device according to [2], wherein
a plurality of frequencies is selected for allocation for transmission of the first signal,
the plurality of selected frequencies includes at least one frequency in an extended portion of the extended frequency range, and
the first signal is transmitted on each of the plurality of selected frequencies at a same timing.

[4]

The communication device according to [3], wherein
the plurality of selected frequencies do not match a frequency on which another communication device that performs wireless communication with the communication counterpart transmits the first signal.

[5]

The communication device according to [3], wherein
when it is determined not to extend the frequency range, the determination unit determines a frequency to be allocated for transmission of the first signal in the frequency range that is not extended, and
the number of frequencies allocated for transmission of the first signal when the frequency range is extended is greater than the number of frequencies allocated for transmission of the first signal when the frequency range is not extended.

[6]

The communication device according to [3], wherein
when it is determined not to extend the frequency range, the determination unit determines a frequency to be allocated for transmission of the first signal in the frequency range that is not extended, and
an interval of frequencies allocated for transmission of the first signal when the frequency range is extended is longer than an interval of frequencies allocated for transmission of the first signal when the frequency range is not extended.

[7]

The communication device according to [3], wherein
when it is determined not to extend the frequency range, the determination unit determines a frequency to be allocated for transmission of the first signal in the frequency range that is not extended, and
all frequencies allocated for transmission of the first signal when the frequency range is not extended are selected as frequencies allocated for transmission of the first signal when the frequency range is extended.

[8]

The communication device according to any one of [2] to [7], wherein
the determination unit determines to extend the frequency range based on a notification from the communication counterpart.

[9]

The communication device according to any one of [2] to [8], wherein
the determination unit determines to restore the extended frequency range based on a notification from the communication counterpart, and
all frequencies of the first signal transmitted after it is determined to restore the extended frequency range are within the frequency range that is not extended.

[10]

The communication device according to any one of [1] to [9], wherein
the wireless communication on the first channel is performed by non-orthogonal multiplex communication.

[11]

The communication device according to any one of [2] to [9], wherein
the first signal is a reference signal or a cyclic prefix.

[12]

The communication device according to [1], wherein
when it is determined not to perform wireless communication on the first channel, the wireless communication unit transmits wireless communication on a second channel for the wireless communication connection to the communication counterpart.

[13]

A communication method including:
receiving wireless communication from a communication counterpart with which wireless communication connection is not established;
determining to perform wireless communication with the communication counterpart on a first channel for transmitting data; and
transmitting wireless communication on the first channel to the communication counterpart when it is determined to perform wireless communication on the first channel.

[14]

The communication method according to [13], further including:
when it is determined to perform wireless communication on the first channel, determining to extend a frequency range in the first channel, the frequency range determined in advance to be allocatable for transmission of a first signal included in the wireless communication transmitted to the communication counterpart; and
determining a frequency to be allocated for transmission of the first signal in the extended frequency range, wherein
the first signal is transmitted on a frequency determined to be allocated for transmission of the first signal in the wireless communication with the communication counterpart on the first channel.

[15]

A communication system including:
one or more first communication devices; and
a second communication device that performs wireless communication with the first communication device, wherein
the first communication device includes:
a determination unit that determines, upon receiving wireless communication from the second communication device which has not established wireless communication connection with the first communication device, to perform wireless communication on a first channel for transmitting data with the second communication device; and
a wireless communication unit that transmits wireless communication on the first channel to the second communication device when it is determined to perform wireless communication on the first channel.

[16]

The communication system according to [15], wherein
when it is determined to perform wireless communication on the first channel, the determination unit determines to extend a frequency range in the first channel, the frequency range determined in advance to be allocatable for transmission of a first signal included in the wireless communication transmitted to the second communication device,
the determination unit determines a frequency to be allocated for transmission of the first signal in the extended frequency range, and
the wireless communication unit transmits the first signal on a frequency determined to be allocated for transmission of the first signal in the wireless communication with the second communication device on the first channel.

[17]

A program executed by a computer, including:
receiving wireless communication from a communication counterpart with which wireless communication connection is not established;
determining to perform wireless communication with the communication counterpart on a first channel for transmitting data; and
transmitting wireless communication on the first channel to the communication counterpart when it is determined to perform wireless communication on the first channel.

[18]

The program according to [17], further including:
when it is determined to perform wireless communication on the first channel, determining to extend a frequency range in the first channel, the frequency range determined in advance to be allocatable for transmission of a first signal included in the wireless communication transmitted to the communication counterpart; and
determining a frequency to be allocated for transmission of the first signal in the extended frequency range, wherein
the first signal is transmitted on a frequency determined to be allocated for transmission of the first signal in the wireless communication with the communication counterpart on the first channel.

### REFERENCE SIGNS LIST

1 Communication system
11 Communication terminal (First communication device)
111 Storage unit
112 Wireless communication control unit (Determination unit)
113 Wireless communication unit
12 Base station device (Second communication device)
2 Base station
31 Range
32 Resource element allocated for transmission of reference signal of communication terminal 11
33 Extended range
34 Resource element allocated for transmission of reference signals of other communication terminals

1. A communication device comprising:
a determination unit that determines, upon receiving wireless communication from a communication counterpart with which wireless communication connection is not established, to perform wireless communication on a first channel for transmitting data with the communication counterpart; and
a wireless communication unit that transmits wireless communication on the first channel to the communication counterpart when it is determined to perform wireless communication on the first channel.

2. The communication device according to claim 1, wherein
when it is determined to perform wireless communication on the first channel, the determination unit determines to extend a frequency range in the first channel, the frequency range determined in advance to be allocatable for transmission of a first signal included in the wireless communication transmitted to the communication counterpart,
the determination unit determines a frequency to be allocated for transmission of the first signal in the extended frequency range, and
the wireless communication unit transmits the first signal on the frequency determined to be allocated for transmission of the first signal in the wireless communication with the communication counterpart on the first channel.

3. The communication device according to claim 2, wherein
a plurality of frequencies is selected for allocation for transmission of the first signal,
the plurality of selected frequencies includes at least one frequency in an extended portion of the extended frequency range, and
the first signal is transmitted on each of the plurality of selected frequencies at a same timing.

4. The communication device according to claim 3, wherein
the plurality of selected frequencies do not match a frequency on which another communication device that performs wireless communication with the communication counterpart transmits the first signal.

5. The communication device according to claim 3, wherein
when it is determined not to extend the frequency range, the determination unit determines a frequency to be allocated for transmission of the first signal in the frequency range that is not extended, and
the number of frequencies allocated for transmission of the first signal when the frequency range is extended is greater than the number of frequencies allocated for transmission of the first signal when the frequency range is not extended.

6. The communication device according to claim 3, wherein
when it is determined not to extend the frequency range, the determination unit determines a frequency to be allocated for transmission of the first signal in the frequency range that is not extended, and
an interval of frequencies allocated for transmission of the first signal when the frequency range is extended is longer than an interval of frequencies allocated for transmission of the first signal when the frequency range is not extended.

7. The communication device according to claim 3, wherein
when it is determined not to extend the frequency range, the determination unit determines a frequency to be allocated for transmission of the first signal in the frequency range that is not extended, and
all frequencies allocated for transmission of the first signal when the frequency range is not extended are selected as frequencies allocated for transmission of the first signal when the frequency range is extended.

8. The communication device according to claim 2, wherein
the determination unit determines to extend the frequency range based on a notification from the communication counterpart.

9. The communication device according to claim 2, wherein
the determination unit determines to restore the extended frequency range based on a notification from the communication counterpart, and
all frequencies of the first signal transmitted after it is determined to restore the extended frequency range are within the frequency range that is not extended.

10. The communication device according to claim 1, wherein
the wireless communication on the first channel is performed by non-orthogonal multiplex communication.

11. The communication device according to claim 2, wherein
the first signal is a reference signal or a cyclic prefix.

12. The communication device according to claim 1, wherein
when it is determined not to perform wireless communication on the first channel, the wireless communication unit transmits wireless communication on a second channel for the wireless communication connection to the communication counterpart.

13. A communication method comprising:
receiving wireless communication from a communication counterpart with which wireless communication connection is not established;
determining to perform wireless communication with the communication counterpart on a first channel for transmitting data; and
transmitting wireless communication on the first channel to the communication counterpart when it is determined to perform wireless communication on the first channel.

14. The communication method according to claim 13, further comprising:
when it is determined to perform wireless communication on the first channel, determining to extend a frequency range in the first channel, the frequency range determined in advance to be allocatable for transmission of a first signal included in the wireless communication transmitted to the communication counterpart; and
determining a frequency to be allocated for transmission of the first signal in the extended frequency range, wherein
the first signal is transmitted on the frequency determined to be allocated for transmission of the first signal in the wireless communication with the communication counterpart on the first channel.

15. A communication system comprising:
one or more first communication devices; and
a second communication device that performs wireless communication with the first communication device, wherein
the first communication device includes:
a determination unit that determines, upon receiving wireless communication from the second communication device which has not established wireless communication connection with the first communication device, to perform wireless communication on a first channel for transmitting data with the second communication device; and
a wireless communication unit that transmits wireless communication on the first channel to the second communication device when it is determined to perform wireless communication on the first channel.

16. The communication system according to claim 15, wherein
when it is determined to perform wireless communication on the first channel, the determination unit determines to extend a frequency range in the first channel, the frequency range determined in advance to be allocatable for transmission of a first signal included in the wireless communication transmitted to the second communication device,
the determination unit determines a frequency to be allocated for transmission of the first signal in the extended frequency range, and
the wireless communication unit transmits the first signal on a frequency determined to be allocated for transmission of the first signal in the wireless communication with the second communication device on the first channel.

17. A program executed by a computer, comprising:
receiving wireless communication from a communication counterpart with which wireless communication connection is not established;
determining to perform wireless communication with the communication counterpart on a first channel for transmitting data; and
transmitting wireless communication on the first channel to the communication counterpart when it is determined to perform wireless communication on the first channel.

18. The program according to claim 17, further comprising:
when it is determined to perform wireless communication on the first channel, determining to extend a frequency range in the first channel, the frequency range determined in advance to be allocatable for transmission of a first signal included in the wireless communication transmitted to the communication counterpart; and
determining a frequency to be allocated for transmission of the first signal in the extended frequency range, wherein
the first signal is transmitted on a frequency determined to be allocated for transmission of the first signal in the wireless communication with the communication counterpart on the first channel.
